(19) United States
(12) Patent Application Publication
(10) Pub. No.: US 2025/0362401 A1
(43) Pub. Date: Nov. 27, 2025

(54) METHOD AND DEVICE FOR INFERENCE IN ULTRA-WIDE BAND SYSTEM (UWB)

(71) Applicant: Samsung Electronics Co., Ltd., Suwon-si, Gyeonggi-do (KR)

(72) Inventors: Karthik Srinivasa GOPALAN, Bangalore (IN); Ankur BANSAL, Bangalore (IN); Aniruddh Rao KABBINALE, Bangalore (IN)

(21) Appl. No.: 18/873,583

(22) PCT Filed: Jun. 9, 2023
(86) PCT No.: PCT/KR2023/007964

§ 371 Date: Dec. 10, 2024

(30) Foreign Application Priority Data
Jun. 10, 2022 (IN) 202241033419
May 26, 2023 (IN) 202241033419

(51) Int. Cl. G01S 13/02; G01S 13/76; G01S 13/87

(52) U.S. Cl. CPC G01S 13/0209; G01S 13/765; G01S 13/878

(57) ABSTRACT

A method and device for inference in an Ultra-Wide Band (UWB) system is disclosed. According to an embodiment of the present disclosure, a method performed by a first device among one or more first devices for sensing in an ultra-wide band (UWB) system including the one or more first devices and a second device being capable of communicating with the one or more first devices is provided, the method comprises receiving, from the second device, a first request message for requesting inference information corresponding to an object of interest (OOI), generating, based on the first request message, a channel impulse response (CIR) report corresponding to the OOI, the CIR report including one or more attributes corresponding to the OOI; processing the CIR report to obtain the inference information corresponding to the OOI, and transmitting, to the second device, a first response message including the inference information corresponding to the OOI.

### CROSS-REFERENCE TO RELATED APPLICATION(S)

This application is a U.S. National Stage application under 35 U.S.C. § 371 of an International application number PCT/KR2023/007964, filed on Jun. 9, 2023, which is based on and claims priority of an Indian Provisional application No. 202241033419, filed on Jun. 10, 2022, in the Indian Patent Office, and of an Indian Complete patent application No. 202241033419 filed on May 26, 2023, in the Indian Patent Office, the disclosure of each of which is incorporated by reference herein in its entirety.

### TECHNICAL FIELD

The present disclosure generally relates to ultra-wide band (UWB) systems, and more particularly relates to UWB systems and methods for inferencing thereof.

### BACKGROUND ART

Ultra-Wide Band (UWB) sensing refers to a technology that utilizes a very high bandwidth pulse of greater than 500 MHz to detect, locate, and identify objects or materials in various environments. Unlike conventional narrowband systems, UWB technology transmits and receives signals over a wide frequency spectrum, enabling enhanced resolution, improved accuracy, and reduced interference. UWB has gained significant attention in recent years due to its potential applications in a wide range of fields, including telecommunications, radar systems, medical imaging, geolocation, and object tracking.

In UWB multi-static Radar or UWB bi-static radar, a Channel Impulse Response (CIR) report is shared by a receiver of sensing signals to a requesting device. At the requesting device, said CIR reports are used in combination (if more than one is available) and processed to arrive at an inference.

In proxy sensing, a requesting device requests sensing to a proxy sensing device. The CIR reports are sent from the receiver of sensing signals to the proxy sensing device, which is further relayed to the requesting device, which processes the CIR reports to arrive at an inference.

However, the conventional process of generating and transmitting CIR reports leads to heavy processing at the requesting device and requires the transfer of large amount of report data over the air, which is both power-consuming and time-consuming.

### DISCLOSURE OF INVENTION

### Technical Problem

The present disclosure provides a method and device for effective and efficient inference for an object of interest (OOI) in a UWB system.

The present disclosure provides a method and device for providing inference information for an OOI efficiently.

### Solution to Problem

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method performed by a first device among one or more first devices for sensing in an ultra-wide band (UWB) system including the one or more first devices and a second device being capable of communicating with the one or more first devices is provided, the method comprises receiving, from the second device, a first request message for requesting inference information corresponding to an object of interest (OOI), generating, based on the first request message, a channel impulse response (CIR) report corresponding to the OOI, the CIR report including one or more attributes corresponding to the OOI; processing the CIR report to obtain the inference information corresponding to the OOI, and transmitting, to the second device, a first response message including the inference information corresponding to the OOI.

According to another embodiment of the present disclosure, a method performed by a second device in an ultra-wide band (UWB) system including one or more first devices for sensing and the second device being capable of communicating with the one or more first devices is provided, the method comprises transmitting, to one or more first devices, a first request message for requesting inference information corresponding to an object of interest (OOI), receiving, from each of the one or more first devices, a first response message including the inference information processed based on a channel impulse response (CIR) report, the CIR report including one or more attributes corresponding to the OOI, and combining one or more inference information received from the one or more first devices to generate concluding sensing inference information corresponding to the OOI.

According to another embodiment of the present disclosure, a first device among one or more first devices for sensing in an ultra-wide band (UWB) system including the one or more first devices and a second device being capable of communicating with the one or more first devices is provided, the first device comprises a transceiver, and a processor configured to receive, through the transceiver from the second device, a first request message for requesting inference information corresponding to an object of interest (OOI), generate, based on the first request message, a channel impulse response (CIR) report corresponding to the OOI, the CIR report including one or more attributes corresponding to the OOI; processing the CIR report to obtain the inference information corresponding to the OOI, and transmit, to the second device through the transceiver, a first response message including the inference information corresponding to the OOI.

According to another embodiment of the present disclosure, a second device in an ultra-wide band (UWB) system including one or more first devices for sensing and the second device being capable of communicating with the one or more first devices is provided, the second device comprises a transceiver, and a processor configured to transmit, to the one or more first devices through the transceiver, a first request message for requesting inference information corresponding to an object of interest (OOI), receive, through the transceiver from each of the one or more first devices, a first response message including the inference information processed based on a channel impulse response (CIR) report, the CIR report including one or more attributes corresponding to the OOI, and combine one or more inference information received from the one or more first devices to generate concluding sensing inference information corresponding to the OOI.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an exemplary environment for inference in an Ultra-Wide Band (UWB) system, according to an embodiment of the present disclosure;

FIG. 2 illustrates an exemplary environment of an alternative system for inference in the UWB system, according to another embodiment of the present disclosure;

FIG. 3 illustrates a schematic block diagram of a sensing device, according to an embodiment of the present disclosure;

FIG. 4 illustrates a schematic block diagram of a requesting device, according to an embodiment of the present disclosure;

FIG. 5 illustrates a process flow for inference in the UWB system, according to an embodiment of the present disclosure;

FIG. 6 depicts an exemplary illustration of inference of an object of interest in the UWB system, according to an embodiment of the present disclosure;

FIG. 7 depicts an exemplary illustration of inference of object of interest(s) in the UWB system, according to an embodiment of the present disclosure;

FIG. 8, FIG. 9, FIG. 10 and FIG. 11 illustrate various process flows for inference in the UWB system, according to one or more embodiments of the present disclosure;

FIG. 12 illustrates a flow chart of a method for inference in the UWB at the sensing device, according to an embodiment of the present disclosure; and

FIG. 13 illustrates a flow chart of a method for inference in the UWB at the requesting device, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### MODE FOR THE INVENTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

As used herein, each of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “Ist” and “2nd” or “first” and “second” may be used to simply distinguish a corresponding component from another, and does not limit the components in other aspect (e.g., importance or order).

The present disclosure is directed towards an Ultra-Wide Band (UWB) system. Specifically, the present disclosure provides a system for inference of Objects of interest (OOIs) in the UWB system. The system includes a plurality of sensing devices to arrive at a concluding inference of the OOIs. Each of the plurality of sensing devices generates a Channel Impulse Response (CIR) report corresponding to the OOIs and analyses the said CIR report to arrive at an independent inference of the OOIs based on a request received from a requesting device. Further, each of the sensing devices transmits the generated inference of the OOIs to the requesting device which is then configured to generate a concluding inference based on the received inference from the plurality of sensing devices.

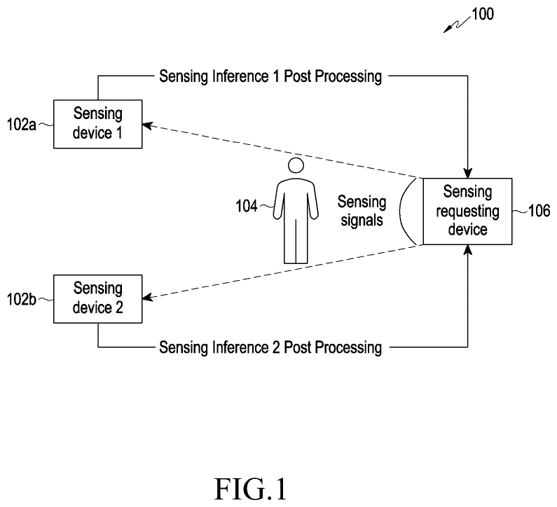

FIG. 1 illustrates an exemplary environment 100 for inference in an Ultra-Wide Band (UWB) system, according to an embodiment of the present disclosure. FIG. 1 illustrates a sensing requesting device 106 (interchangeably referred to as “the requesting device 106), a pair of sensing devices 102a, 102b (interchangeably referred to as “the sensing device 102”), and an Object of Interest (OOI) 104. While only one OOI 104 is depicted in FIG. 1, it may be apparent to a person skilled in the art that there may be more than one OOI 104 in the environment 100. Further, in the illustrated embodiment, only a pair of sensing devices 102 has been shown, however, embodiments intend to include or otherwise cover any number of sensing devices 102 which may be required to implement the desired objective of the present disclosure i.e., for inference in the UWB system.

The requesting device 106 and/or the sensing device 102 may utilize a large portion (for example, frequency range between 3.1 GHz to 10.6 GHz) of the radio frequency spectrum to transmit and receive signals and therefore may be collectively referred to as the UWB system. The sensing device 102 of the UWB system uses UWB signals to detect and analyze information about the surrounding environment, and therefore may provide high-resolution and accurate measurements over conventional non-UWB systems.

The sensing device 102 may include any suitable device configured to detect, transmit, and/or receive UWB signals to generate information about the surrounding environment. Examples of the sensing device 102 in an environment may include, but are not limited to, an imaging device, a positioning device, a location device, an object positioning and tracking device, a vital sign monitoring device, a temperature sensing device, a collision avoidance device, a wearable device, a radar device, a UWB anchor node, a UWB tag, a gesture recognition device, an environment monitoring device, and so forth. The sensing device 102 may be communicably coupled to the requesting device 106.

In an exemplary embodiment, each sensing device 102 may be configured to receive a request for inference information corresponding to the OOI 104 from the requesting device 106. The request for inference information may include a request for one or more attributes corresponding to the OOI 104. Examples of such attributes corresponding to the OOI 104 may include, but are not limited to, a detection of the OOI 104, a location corresponding to the OOI 104, an identification corresponding to the OOI 104, a confidence level corresponding to the OOI 104, a Channel Impulse Response (CIR) report corresponding to the OOI 104, and one or more body parameters corresponding to the OOI 104.

The sensing device 102 may be configured to transmit and receive signals in the UWB frequency spectrum to sense the OOI 104, in response to the request for inference from the requesting device 106. Particularly, the sensing device 102 may be configured to emit UWB pulses and analyze reflected and/or scattered signals to infer the presence and/or characteristics of the OOI. In an embodiment, the pulses transmitted by the sensing device 102 may propagate through the environment 100, and when said pulses encounter the OOI 104, the transmitted pulses are partially absorbed, scattered, and/or reflected. Such absorption, scatter, and reflection transmission are based on properties and/or characteristics of the OOI 104. Thus, based on the reception of such reflected and/or scattered signals, the sensing device 102 may determine information corresponding to the OOI 104. The information corresponding to the OOI 104 may include the one or more attributes as requested by the requesting device 106.

In some embodiments, the sensing device 102 may be configured to process and analyze the received reflected and/or scattered signals, and/or the information to perform feature extraction of the OOI 104. The sensing device 102 may be configured to utilize techniques such as, but not limited to, time-domain analysis, frequency-domain analysis, or correlation analysis, to extract the relevant features and/or attributes of the OOI 104.

In an embodiment, the sensing device 102 may be configured to generate a CIR report based on the reflected and/or scattered signals which are received as the response to the transmitted pulse signals. The CIR report may include the extracted relevant features and/or the attributes of the OOI 104, as discussed above. In some embodiments, the sensing device 102 may determine a Time-of-Flight (TOF) of each response impulse/signal by determining a time delay between the transmitted pulse and the corresponding received impulse. Using the TOF measurements, the sensing device 102 may construct the Channel Impulse Response (CIR) by plotting the amplitude and phase of each impulse as a function of time. The CIR may represent the multipath propagation characteristics of the environment and provides insights related to delays, strengths, and phase shifts of the different propagation paths. Further, the sensing device 102 may be configured to comply data of CIR to generate a comprehensive CIR report which may include information such as, but not limited to, the number of impulses, the corresponding amplitudes, the TOF measurements, and additional information about the multipath environment.

Moreover, the sensing device 102 may be configured to process the CIR report to generate inference information corresponding to the OOI 104. In an embodiment, the sensing device 102 may utilize various techniques such as, but not limited to, signal processing, feature extraction, and machine learning techniques to generate the inference information corresponding to the OOI 104 from the CIR report. Embodiments are exemplary in nature and the sensing device 102 may be configured to utilize any suitable object inference, identification and/or classification technique to generate the inference information corresponding to the OOI 104 from the CIR report. In an embodiment, the inference information may include an inference of the OOI 104, a partial inference of the OOI 104, or a probability indicating a match of the one or more attributes corresponding to the OOI 104 with pre-stored object information. In some other embodiments, the inference information may also include the detection of OOI 104, the location corresponding to the OOI 104, the identification corresponding to the OOI 104, the confidence level corresponding to the OOI 104, the CIR report corresponding to the OOI 104, or the one or more body parameters corresponding to the OOI 104. The sensing device 102 may further be configured to transmit the generated inference information corresponding to the OOI 104 to the requesting device 106.

In the illustrated embodiment, the OOI 104 may correspond to a person standing in front of the requesting device 106. In alternative embodiments, the OOI 104 may correspond to humans, objects (for example, furniture and obstacles, etc.), equipment (for example, mechanical tools, industrial and healthcare devices, etc.), pets or animals, and so forth, which may be located within a range of UWB signals from the requesting device 106 and/or the sensing device 102. Further, in the illustrated embodiment, only a single OOI has been shown, however embodiments of the present disclosure either cover or intend to cover any number of OOIs.

In an embodiment, the requesting device 106 may correspond to an electronic device configured to transmit and/or receive wireless signals. The requesting device 106 may include any sensing unit. Examples of the requesting device 106 may include, but are not limited to, a television, a smartphone, a tablet, a personal computing device, a laptop, a UWB anchor, an occupancy detection device, a security device, a wearable device, a collision avoidance device, a robotic device, a smart toy, and so forth. In an embodiment, the requesting device 106 may act as one of the plurality of sensing devices 102 in the environment 100. The requesting device 106 may be configured to generate the request for inference information corresponding to the OOI 104. The requesting device 106 may generate the request for inference information based on any of a user input, a trigger event, a signal detection, and so forth. For instance, in case the requesting device 106 is television, the requesting device 106 may generate the request for inference information when the requesting device 106 receives a signal from a remote control device associated with the requesting device 106. Further, the requesting device 106 may be configured to transmit the generated request for inference information to the plurality of sensing devices (for example, the pair of sensing devices 102). The requesting device 106 may receive the inference information corresponding to the OOI 104 from each of the sensing device 102, in response to the transmitted request for inference information. Thus, instead of CIR report, the requesting device 106 may receive processed information from the sensing device 102 which indicates the inference of the OOI 104 as determined by the sensing device 102. Thus, the present disclosure reduces the processing and computation load from the requesting device 106. The requesting device 106 may also be configured to combine the received inference information from each of the sensing devices 102a and 102b to generate a concluding sensing inference corresponding to the OOI 104.

Thus, by performing the processing of the impulse signals at the sensing device 102, the overall load of the system and/or the requesting device 106 is significantly reduced. Further, as the inference information generated by the sensing device 102 is lower in size as compared to the CIR reports, the system significantly reduces over-the-air transmission of the data.

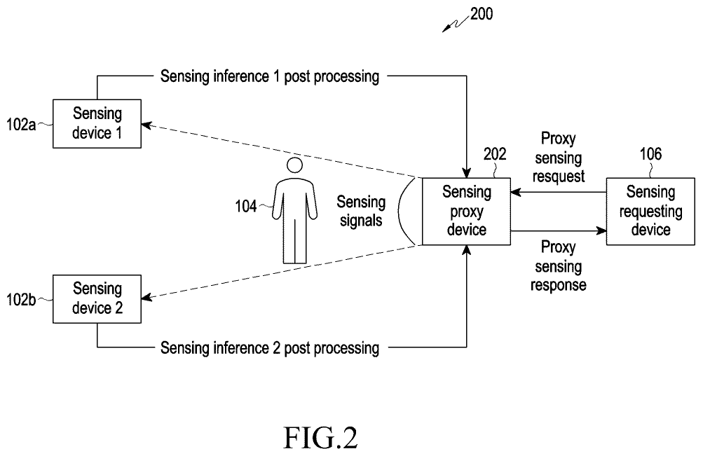

FIG. 2 illustrates an exemplary environment 200 of an alternative system for inference in the UWB system, according to another embodiment of the present disclosure.

Specifically, FIG. 2 illustrates the pair of sensing devices 102a, 102b, the sensing requesting device 106, the OOI 104, and a sensing proxy device 202. The components of the environment 200 which are similar to the components of the environment 100 are provided with same reference numerals, and a description of said components has been omitted for the sake of brevity.

Here, the sensing proxy device 202 may act as an intermediary between the requesting device 106 and the OOI 104 or the sensing device 102. Examples of the sensing proxy device 202 may include, but are not limited to, an imaging device, a positioning device, a location device, an object positioning and tracking device, a vital sign monitoring device, a temperature sensing device, a collision avoidance device, a wearable device, a radar device, a UWB anchor node, a UWB tag, a gesture recognition device, an environment monitoring device, equipment, a mobile device, a portable computing device, and so forth.

In an embodiment, the requesting device 106 may use the sensing proxy device 202 for signal amplification. For instance, the UWB signals may be attenuated or weakened when such signals propagate through the environment 200 due to obstacles or walls. In such a scenario, the requesting device 106 may use the sensing proxy device 202 to amplify or boost the signal strength before the signals reach the sensing device 102, the OOI 104, and/or the requesting device 106. Therefore, the sensing proxy device 202 may ensure reliable and accurate sensing results. In some other embodiments, the sensing proxy device 202 may be used to enable direct sensing and/or improve inference of the OOI 104. For instance, in a scenario where the requesting device 106 and/or the sensing device 102 may not be able to directly reach the OOI 104 due to obstacles or signal blockage, the sensing proxy device 202 may be strategically placed to capture the UWB signals transmitted from the requesting device 106 and/or the sensing device 102. Further, the sensing proxy device 202 may be strategically placed to reflect or refract the signals towards the OOI 104.

In an embodiment, the requesting device 106 may utilize the sensing proxy device 202 for inference of the OOI 104 from multiple perspectives. For instance, the sensing proxy device 202 may be placed at different location and/or different angle from the OOI 104 as compared to the sensing device 102 to target the OOI 104 from different perspectives. Thus, by obtaining inference from a different perspective, the sensing proxy device 202 may improve the overall accuracy, object recognition, and/or tracking capability of the requesting device 106.

In some embodiments, the requesting device 106 may utilize the sensing proxy device 202 for power efficiency. For instance, the requesting device 106 requires energy to transmit and receive multiple signals to and from the plurality of sensing devices 102. By employing the sensing proxy device 202, the requesting device 106 may offload some of the sensing tasks, thereby reducing the overall power consumption of the requesting device 106. Specifically, the sensing proxy device 202 may be configured to perform certain processing tasks or continuous monitoring for the requesting device 106, while the requesting device 106 may remain in low-power or sleep mode until a specific event or condition requires the activation of the requesting device 106. For instance, the requesting device 106 may remain in low-power or sleep mode until the sensing proxy device 202 generates the concluding inference information corresponding to the OOI 104.

In some embodiments, the sensing proxy device 202 may be configured to provide additional capabilities to the requesting device 106. For instance, the requesting device 102 may not have sufficient resources to directly communicate with the plurality of sensing devices 102. In such a scenario, the various resource of the sensing proxy device 202 may be used to perform said communication.

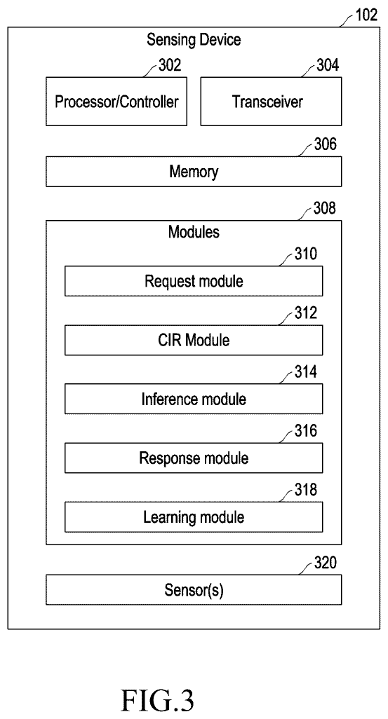

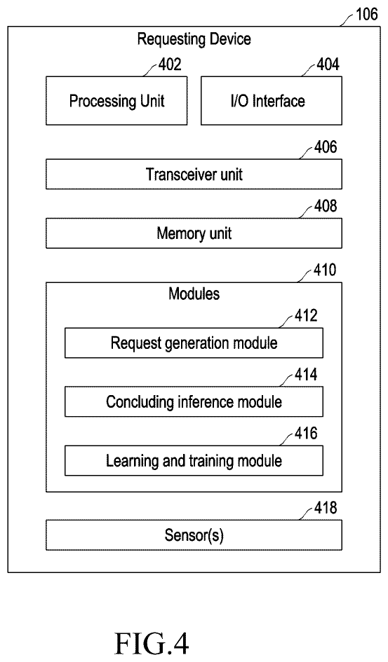

In an exemplary embodiment, the sensing proxy device 202 may be configured to receive a proxy sensing request from the sensing requesting device 106. In response to the reception of the proxy sensing request, the sensing proxy device 202 may act as the sensing requesting device 106, as explained in reference to FIG. 1. Specifically, in response to the reception of the proxy sensing request, the sensing proxy device 202 may be configured to generate a request for inference information corresponding to the OOI 104. The sensing proxy device 202 may be configured to transmit the generated request to the sensing device 102. The sensing proxy device 202 may also be configured to receive the inference information corresponding to the OOI 104 from the sensing device 102. In some embodiments, the sensing proxy device 202 may be configured to combine the received inference information from each of the sensing device 102a and 102b to generate a concluding sensing inference corresponding to the OOI 104. The sensing proxy device 202 may be configured to transmit the generated concluding sensing inference as a proxy sensing response to the sensing requesting device 106. In other embodiments, the sensing proxy device 202 may be configured to directly transmit the received sensing inference information from each of the sensing devices 102 as the proxy sensing response to the sensing requesting device 106. In such a scenario, the sensing requesting device 106 may be configured to process the proxy sensing response including the received sensing inference information to generate the concluding sensing inference for the OOI 104. In an embodiment, the sensing inference may correspond to detection and/or identification of the OOI 104 based on the received request. The sensing proxy device 202 may have a structure of FIG. 3 or FIG. 4 to be described later.

In the illustrated embodiment, only a single sensing proxy device 102 has been shown, however, embodiments either cover or intend to cover any number of the sensing proxy device 202 required by the sensing requesting device 106 to an effective and efficient inference of the OOI 104 Thus, the sensing proxy device 102 may enable effective and efficient inference generation for the OOI 104.

In this disclosure, the sensing device, the requesting device, and the sensing proxy device may be interchangeably referred to as a first device, a second device, and a third device, respectively.

FIG. 3 illustrates a schematic block diagram of the sensing device 102, according to an embodiment of the present disclosure. The sensing device 102 may be configured to generate inference information corresponding to the OOI 104. The sensing device 102 may be configured to operate as a standalone device or a device embedded and/or included within an electronic system. The sensing device 102 may be configured to transmit and receive UWB signals/pulse to generate inference information corresponding to the OOI 104.

The sensing device 102 may include one or more processors/controllers 302 (hereinafter referred to as “the processor 302”), a transceiver 304, a memory 306, one or more modules 308, and one or more sensors 320. In an exemplary embodiment, the processor 302 may be operatively coupled with the transceiver 304, the memory 306, the module(s) 308, and the sensor(s) 310.

The processor 302 may include specialized processing units such as, but not limited to, integrated system (bus) controllers, memory management control units, floating point units, digital signal processing units, etc. In one embodiment, the processor/controller 202 may include a central processing unit (CPU), a Graphics Processing Unit (GPU), or both. The processor 302 may be one or more general processors, Digital Signal Processors (DSPs), Application-Specific Integrated Circuits (ASIC), field-programmable gate arrays, servers, networks, digital circuits, analog circuits, combinations thereof, or other now known or later developed devices for analyzing and processing data. The processor 302 may execute a software program, such as code generated manually (i.e., programmed) to perform the desired operation.

In an exemplary embodiment, the processor 302 may be configured to receive a first request from the requesting device 106 for inference information corresponding to the OOI 104. In an embodiment, the request may define the one or more attributes corresponding to the OOI 104 which are required for inference of the OOI 104. Examples of such attributes may include, but are not limited to, a location corresponding to the OOI 104, an identification corresponding to the OOI 104, a confidence level corresponding to the OOI 104, a CIR report corresponding to the OOI 104, and one or more body parameters corresponding to the OOI 104.

The location corresponding to the OOI 104 may be based on a distance of the OOI 104 with respect to the sensing device 102 and/or the requesting device 106. The identification corresponding to the OOI 104 may correspond to a type of OOI 104, for example, humans, objects, animals, and so forth. In some embodiments, the identification corresponding to the OOI 104 corresponds to a type of OOI 104 based on numbers, for instance whether the OOI 104 corresponds to a pair of objects, a group of people, a bundle, and/or a stack. The confidence level corresponding to the OOI 104 may indicate a level of confidence in the inference of the OOI 104 by the sensing device 102. For instance, a first sensing device 102 generates the inference of the OOI 104 based on two attributes, whereas a second sensing device 102 generates the inference of the OOI 104 based on four attributes, in such a case the confidence level of OOI 104 as indicated by the second sensing device 102 will be higher as compared to the first sensing device 102. Therefore, based on the number of attributes used by the sensing device 102 to generate the inference of the OOI 104, the sensing device 102 may generate the confidence level of the OOI 104.

The CIR report corresponding to the OOI 104 may be a collection of information by the sensing device 102. Further, the body parameters corresponding to the OOI 104 may cover characteristics of the OOI 104 such as, but not limited to, a height of the OOI 104, a weight of the OOI 104, a length of the OOI 104, a weight of the OOI 104, a temperature of the OOI 104, and so forth. Moreover, embodiments are exemplary in nature, the request for inference may include any number of attributes corresponding to the OOI 104 for generating inference of the OOI 104 by the sensing device 102 and/or the requesting device 106.

The processor 302 may also be configured to generate a CIR report corresponding to the OOI 104 upon receiving the first request for inference information. Specifically, the processor 302 may be configured to determine the one or more attributes of the OOI 104 requested in the received request for the inference. In some embodiments, the processor 302 may generate the CIR report based on the determined attributes of the OOI 104. Thereafter, the processor 302 may process the corresponding CIR report to generate the inference information corresponding to the OOI 104. The processor 302 may be configured to utilize various techniques such as, but not limited to, signal processing, data analysis, machine learning, and so forth, to process the generated CIR reports and/or the determined attributes to generate the inference information corresponding to the OOI 104.

The inference information may indicate information such as, but not limited to, an inference of the OOI 104, a partial inference of the OOI 104, or a probability indicating a match of the one or more attributes corresponding to the OOI 104 with pre-stored object information. For instance, the processor 302 may be configured to compare the determined attributes corresponding to the OOI 104 with one or more pre-stored attributes. Based on the match of the attributes, the processor 302 may determine whether the sensing device 102 is able to infer the OOI 104, or partially infer the OOI 104. In some embodiments, when the processor 302 is not able to generate the inference of the OOI 104, the processor 302 may indicate a probability of the inference in the inference information.

The processor 302 may further be configured to transmit the generated inference information corresponding to the OOI 104 to the requesting device 106. Similarly, a processor associated with each of the plurality of the sensing device 102 may generate and transmit the inference information corresponding to the OOI 104 to the requesting device 106.

In some embodiments, the processor 302 may be configured to receive a second request for additional inference(s) information corresponding to the OOI 104. The additional inference information may be required by the requesting device 106 to generate a concluding inference of the OOI 104. The second request may correspond to a request for one or more additional attributes required for the generation of a concluding sensing inference by the requesting device 106. In response to the reception of the second request, the processor 302 may be configured to re-process the generated CIR report and/or the determined attributes corresponding to the OOI 104 to generate the additional inference information corresponding to the OOI 104. The processor 302 may be configured to transmit the generated additional inference information to the requesting device 106.

The processor 302 may be disposed in communication with a network via the transceiver 304. The transceiver 304 may act as a network interface for the processor 302. In some embodiments, the transceiver 304 may include inference that may employ communication code-division multiple access (CDMA), high-speed packet access (HSPA+), global system for mobile communications (GSM), long-term evolution (LTE), WiMax, or the like, etc.

In particular, the transceiver 304 may enable the sensing device 102 to communicate with other sensing device 102, and/or the requesting device 106. In some embodiments, when the OOI 104 is an electronic device, the transceiver 304 may enable the sensing device 102 to communicate with the OOI 104. In an exemplary, the transceiver 304 may be capable of transmitting and receiving UWB signals which are required to generate the inference of the OOI 104 in the UWB system.

In some embodiments, the transceiver 302 be implemented with a network interface to employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the sensing device 102 may communicate with other sensing device 102 and/or the requesting device 106. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The processor 302 may also be communicably coupled with the memory 306. The memory 306 may be configured to store data, and instructions executable by the processor 302. In one embodiment, the memory 306 may communicate via a bus within the sensing device 102. The memory 306 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 306 may include a cache or random-access memory for the processor 302. In alternative examples, the memory 306 is separate from the processor 302, such as a cache memory of a processor, the system memory, or other memory. The memory 306 may be an external storage device or database for storing data. The memory 306 may be operable to store instructions executable by the processor 302. The functions, acts or tasks illustrated in the figures or described may be performed by the programmed processor 302 for executing the instructions stored in the memory 306. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

In an exemplary embodiment, the memory 306 may store the request and/or the associated attributes received from the requesting device 102. The memory 306 may also be configured to store instruction/data/information required by the processor 302 to generate the CIR report corresponding to the OOI 104. The memory 306 may further be configured to store the various attributes and/or the CIR report corresponding to the OOI 104, as determined by the processor 302. Further, the memory 306 may include an operating system for performing one or more tasks of the sensing device 102, as performed by a generic operating system in the communications domain.

In some embodiments, the modules 308 may be included within the memory 306. The one or more modules 308 may include a set of instructions that may be executed to cause the sensing device 102 to perform any one or more of the methods/processes disclosed herein. The one or more modules 308 may be configured to perform the steps of the present disclosure using the data stored in the memory 306, for inference of the OOI 104 in the UWB system, as discussed herein. In an embodiment, each of the one or more modules 306 may be a hardware unit which may be outside the memory 306.

The modules 308 may include, but not be limited to, a request module 310, a CIR module 312, an inference module 314, a response module 316, and a learning module 318. The request module 310 may be configured to receive and/or process one or more requests for inference information corresponding to the OOI 104 from the requesting device 106. The CIR module 312 may be configured to generate the CIR report corresponding to the OOI 104 in response to the one or more requests for the inference information. The inference module 312 may be configured to process the generated CIR report to generate the inference information corresponding to the OOI 104. The response module 316 may be configured to transmit the generated inference information as a response to the one or more requests received from the requesting device 106. The learning module 318 may be configured to monitor the requests received from the requesting device 106 to learn and predict the requested attributes and/or inference of the OOI by the requesting device 106.

The sensing device 102 includes the one or more sensors 320. The one or more sensors may include, but are not limited to, temperature sensors, pressure sensors, proximity sensors, light sensors, accelerometers, gyroscopes, magnetometers, humidity sensors, gas sensors, ph sensors, motion sensors, and ultrasonic sensors, and so forth. The sensors 320 may be configured to determine the one or more attributes corresponding to the OOI 104.

In some embodiments, the sensing device 102 may also include Input/Output (I/O) interface (not shown) which may be configured to enable a user to interact with the sensing device 102. The I/O interface may include devices such as, but not limited to, a microphone, a touch screen, a touchpad, a storage device, a transceiver, a video device/source, a video display (e.g., cathode ray tube (CRT), liquid crystal display (LCD), light-emitting diode (LED), plasma, Plasma Display Panel (PDP), Organic light-emitting diode display (OLED) or the like), audio speaker, and so forth.

Embodiments are exemplary in nature and the sensing device 102 may include any suitable additional component which may be required to implement the desired objective of the present disclosure, i.e., to generate inference information corresponding to the OOI 104.

Further, the present disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processor/controller 302 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. Likewise, the additional connections with other components of the sensing device 102 may be physical or may be established wirelessly. The network may alternatively be directly connected to the bus. For the sake of brevity, the architecture and standard operations of the processor 302, the transceiver 304, the memory 306, and the sensor(s) 320 are not discussed in detail.

FIG. 4 illustrates a schematic block diagram of the requesting device 106, according to an embodiment of the present disclosure. The requesting device 106 may be configured to generate inference information corresponding to the OOI 104. The requesting device 106 may be configured to operate as a standalone device or a device embedded and/or included within an electronic system. The requesting device 106 may be configured to transmit and receive UWB signals/pulse to generate inference of the OOI 104.

The requesting device 106 may include a processing unit 402, an I/O interface 404, a transceiver unit 406, a memory unit 408, and one or more modules 410. Some of the components of the requesting device 106 may have a similar configuration as the sensing device 102, as shown in FIG. 3. For instance, the processing unit 402 may have a similar configuration as the processor 302. Similarly, the transceiver unit 406 and the memory unit 408 may have similar configurations as the transceiver 304 and the memory 306, respectively. Moreover, the I/O interface 404 may have a similar configuration as discussed above in reference to FIG. 3. Therefore, a description corresponding to the configuration and implementation corresponding to said components has been omitted for the sake of brevity.

The processing unit 402 may be configured to generate one or more requests for inference information corresponding to the OOI 104. In an embodiment, the processing unit 402 may generate the request(s) for inference information based on one or more user inputs. The processor 402 may be communicably coupled to the I/O interface 404 to receive the one or more user inputs from a user of the requesting device 106. In another embodiment, the processing unit 402 may generate the request(s) for inference information based on the detection of an event. For instance, in response to the detection of an object in front of the requesting device 106, the processing unit 402 may generate a request for the inference information corresponding to said information. The requesting device 106 may include one or more sensors 418 to detect the event for a generation of the request for inference information. The processing unit 402 may be communicably coupled to the sensor(s) 418 to detect the event to generate the request(s) for inference information corresponding to the OOI 104. The request(s) for inference information may include requested information/attributes corresponding to the OOI 104. Examples of said attributes corresponding to the OOI 104 may include, but are not limited to, the location corresponding to the OOI 104, the identification corresponding to the OOI 104, the confidence level corresponding to the OOI 104, the CIR report corresponding to the OOI 104, the one or more body parameters corresponding to the OOI 104, and so forth.

The processing unit 402 may also be configured to transmit the generated request(s) to the one or more sensing device 102. In an embodiment, the processing unit 402 may be communicably coupled with the transceiver unit 406 to transmit the generated request(s) to the sensing device(s) 102. The transceiver unit 406 may be configured to receive and transmit the signals to and from the requesting device 106.

The processing unit 402 may further be configured to receive the inference information corresponding to the OOI 104 from each of the sensing devices 102 via the transceiver unit 406. In some embodiments, the processing unit 402 may also receive one or more attributes corresponding to the OOI 104 as determined by the sensing device 102.

The processing unit 402 may be configured to process the received inference information from each of the sensing devices 102 to generate a concluding sensing inference corresponding to the OOI 104. Specifically, the processing unit 402 may be configured to combine the received inference information from each of the one or more sensing devices 102 to generate the concluding sensing inference corresponding to the OOI 104. In some embodiments, the processing unit 402 may also be configured to analyze the received inference information corresponding to the OOI 104 from each of the one or more sensing devices 102 to determine a requirement for one or more additional attributes to generate the concluding sensing inference. The processing unit 402 may compare a confidence level of the generated concluding sensing inference with a predefined threshold to determine whether there is the required for the one or more additional attributes. The predefined threshold may be stored in the memory unit 408. Moreover, the processing unit 402 may be configured to transmit a request for the additional inference corresponding to the determined additional attributes to the one or more sensing devices 102.

In some embodiments, the processing unit 402 may be configured to compare a confidence level corresponding to the received inference information with one or more predefined thresholds corresponding to the confidence level. and combine the inference information based on a result of the comparison to generate the concluding sensing inference of the OOI 104.

The I/O interface 404 may enable the user of the requesting device 106 to interact with the requesting device 106, the sending device 102, and/or the OOI 104. The transceiver unit 406 may be configured to establish a communication connection between the requesting device 106 and the sensing device 102. In some embodiments, the transceiver unit 406 may also be configured to establish a communication connection between the requesting device 106 and the OOI 104, in case the OOI 104 supports the communication with the requesting device 106. The memory unit 408 may be configured to store information corresponding to the one or more sensing devices 102 to enable the requesting unit 106 to effectively transmit the request for the inference information. The memory unit 408 may also be configured to store information received from the one or more sensing devices 102 in response to the transmitted request(s). The memory unit 408 may further be configured to store instructions/data required by the processing unit 402 to implement the desired objective of the present disclosure, i.e., for inference of the OOI 104 in the UWB system.

The requesting device 106 may also include the modules 410 configured to perform one or more operations of the requesting device 106. The modules 410 may include a request generation module 412, a concluding inference module 414, and a learning and training module 416. The request generation module 412 may be configured to generate and transmit requests for inference information to the sensing device 102. The concluding inference module 414 may be configured to receive and combine the inference information from each of the sensing devices 102 to generate the concluding inference for the OOI 104. Further, the learning and training module 416 may be configured to analyze a plurality of receive responses to predict future responses from the sensing device 102. In some embodiments, the learning and training module 416 may analyze a plurality of requests for inference information generated by the requesting device 106 to predict a future request for inference information. In some embodiments, the learning and training module 416 may be configured to analyze a plurality of concluding inferences generated by the requesting device 106 to predict a future concluding inference of an OOI. The learning and training module 416 may employ any suitable technique such as, but not limited to, machine learning, big data analysis, artificial intelligence, and so forth to learn and predict the behaviour of the requesting device 106. In some embodiments, the modules 410 may include a set of instructions stored in the memory unit 408. In other embodiments, the modules 410 may include hardware component(s) located outside the memory unit 408.

In an embodiment, the requesting device 106 may also include the sensor(s) 418 configured to determine the attributes and/or the inference information corresponding to the OOI 104.

Further, the present disclosure contemplates a computer-readable medium that includes instructions or receives and executes instructions responsive to a propagated signal. Further, the instructions may be transmitted or received over the network via a communication port or interface or using a bus (not shown). The communication port or interface may be a part of the processing unit 402 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. Likewise, the additional connections with other components of the requesting device 106 may be physical or may be established wirelessly. The network may alternatively be directly connected to the bus. For the sake of brevity, the architecture and standard operations of the processing unit 402, the I/O interface 404, the transceiver unit 406, the memory unit 408, and the sensor(s) 418 are not discussed in detail.

In reference to FIGS. 3 and 4, at least one of the plurality of modules may be implemented through an AI model. A function associated with AI may be performed through the non-volatile memory, the volatile memory, and the processor.

The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a robot) using a plurality of learning data to cause, allow, or control the target device to decide or predict. Examples of learning techniques include, but are not limited to, supervised learning, unsupervised learning, semi-supervised learning, or reinforcement learning.

According to the disclosure, in a method of an electronic device, a method for inference of the OOI may use an artificial intelligence model to generate inference of the OOI by using sensor data. The processor may perform a pre-processing operation on the data to convert it into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation.

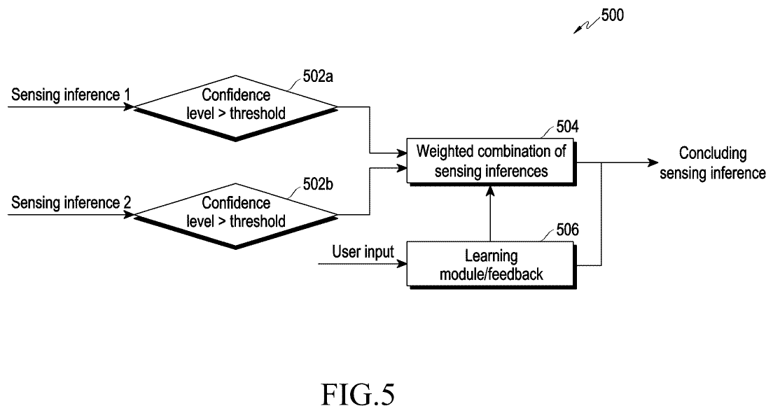

FIG. 5 illustrates a process flow 500 for inference in the UWB system, according to an embodiment of the present disclosure. FIG. 5 may be disclosed in reference to components explained in FIGS. 1-4. The process flow 500 may be implemented at the requesting device 106. The requesting device 106 may receive a sensing inference 1 from a first sensing device 102a, and a sensing inference 2 from a second sensing device 102b. The sensing inference 1 and 2 may indicate the inference information generated by the sensing device 102a, and 102b, respectively. At block 502a, the requesting device 106 may compare a confidence level of the sensing inference 1 with a predefined threshold. In case, the confidence level of the sensing inference 1 is greater than the predefined threshold, the requesting device 106 may utilize the sensing inference 1 for a weighted combination of sensing inference to generate the concluding inference of the OOI 104. However, in case the confidence level of the sensing inference 1 is less than the predefined threshold, the requesting device 106 may generate an additional request for the inference information. Similarly, the requesting device 106 may compare the sensing inference 2 with the predefined threshold at block 502b. At block 504, the requesting device 106 may generate a weighted combination of the sensing inference 1 and 2 to generate a concluding sensing inference (interchangeably referred to as “concluding inference” of the OOI 104. In some embodiments, the requesting device 106 may also include a learning/feedback module 506 configured to receive user input to improve the quality of the concluding inference of the OOI 104.

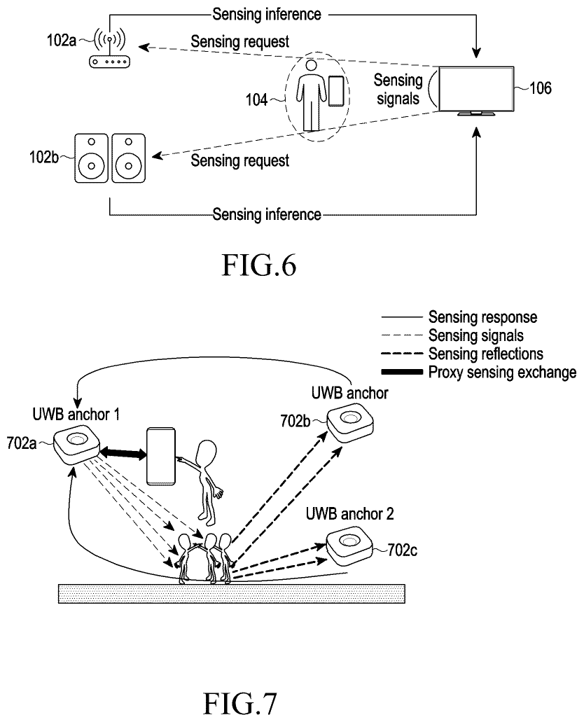

FIG. 6 depicts an exemplary illustration of inference of the OOI 104 in the UWB system 100, according to an embodiment of the present disclosure. Further, FIG. 6 may be explained in reference to FIGS. 1-5. In the illustrated embodiment, the sensing device 102a may correspond to a UWB enabled wireless hub 102. The sensing device 102b may correspond to a UWB enabled music system. The OOI 104 may correspond to a user with a mobile device, and the requesting device 106 may correspond to a UWB-enabled television device (hereinafter referred to as “the TV 106”). In the illustrated scenario, the user uses a remote control device to operate the TV 106 based on his/her profile or to enable parental control based on the identification of the user. In such a scenario, the TV 106 may generate a UWB sensing request for inference of the user and transmit the request to the UWB enabled wireless hub 102a and the UWB enabled music system 102b. Thus, based on a command received from the remote control device, the TV 106 may generate the UWB sensing request.

The UWB enabled wireless hub 102a and the UWB enabled music system 102b may perform the sensing of the OOI 104 and may transmit the generated sensing inference to the TV 106. The generated sensing inference may one or more characteristics/attributes of the user. The characteristics/attributes of the user may include, but not limited to, the height of the user, the weight of the user, the temperature of the user, the location of the user, and so forth. The TV 106 may receive the inference information generated by the UWB enabled wireless hub 102a and the UWB enabled music system 102b, and combine said inference information to generate a concluding inference about the user. The concluding inference may indicate whether the user is a child, a teen, an adult, or an elder person. The TV 106 may generate the concluding inference based on one or more attributes and/or inference information generated by the UWB enabled wireless hub 102a and the UWB enabled music system 102b. The TV 106 may take an appropriate action based on the generated concluding inference about the OOI 104.

FIG. 7 depicts an exemplary illustration of inference of the OOI 104 in the UWB system, according to an embodiment of the present disclosure. FIG. 7 may be explained in reference to FIGS. 1-5. Specifically, FIG. 7 illustrates a scenario of a shopping mall where multiple UWB anchors 702a-702c which are part of an UWB infrastructure are disposed at various locations of the shopping mall. Further, a user wishes to identify a crowd at a particular store in the shopping mall. In such a scenario, the user interacts with one of the UWB anchor 702a using a UWB enabled smartphone device of the user. The user may share a request to identify the crowd at the particular store with the UWB anchor 702a using the UWB enabled smartphone device of the user. Based on such a request, the UWB anchor 702a may transmit a sensing request signal to the other UWB anchors 702b and 702c. Each of the UWB anchors 702b and 702c may sense the environment based on the received sensing request signal to generate the inference response signals. Further, each of the UWB anchors 702b and 702c may transmit the generated inference response signals to the UWB anchor 702a.

In an embodiment, the signals which may be required to generate the inference response signals are generated by the UWB anchor 702a, whereas each of the other UWB anchors 702b and 702c may receive the reflected and/or refracted signals to generate the inference response signals. Moreover, the UWB anchor 702a may generate a concluding inference signal based on the received inference response signals and transmit said concluding inference signal to the UWB enabled smartphone device of the user. The concluding inference signal may indicate whether the particular store is crowded. Therefore, the UWB anchor 702a may act as a proxy sensing device for the UWB enabled smartphone device of the user. Further, the inference information about the crowd as generated by the UWB anchor 702a may help the user to navigate better and avoid crowded places in the shopping mall.

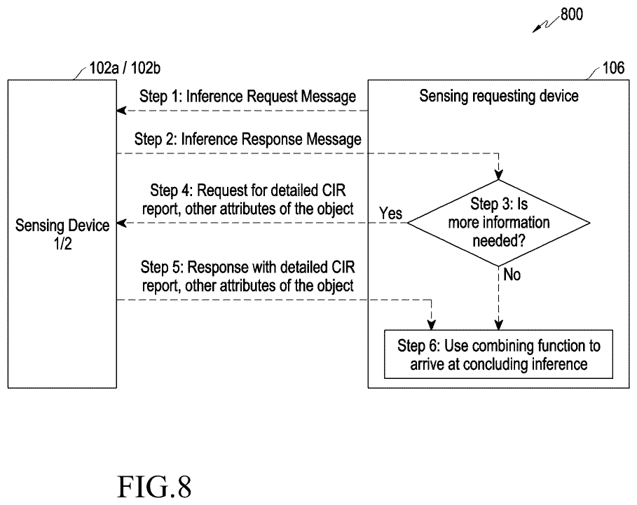

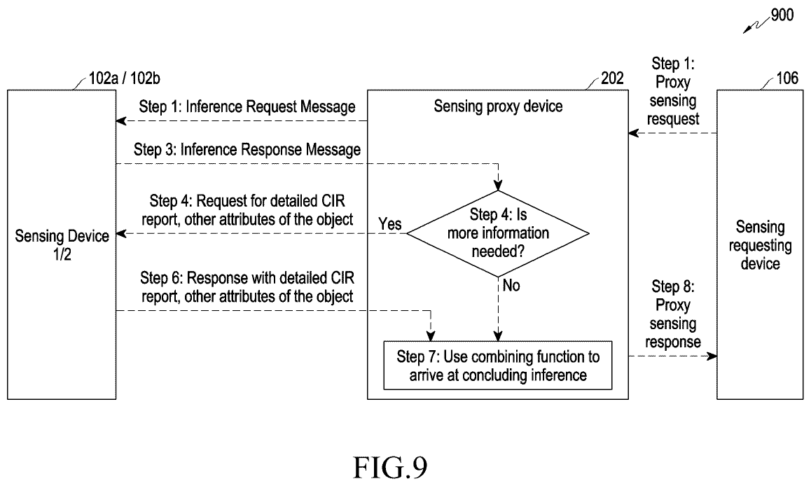

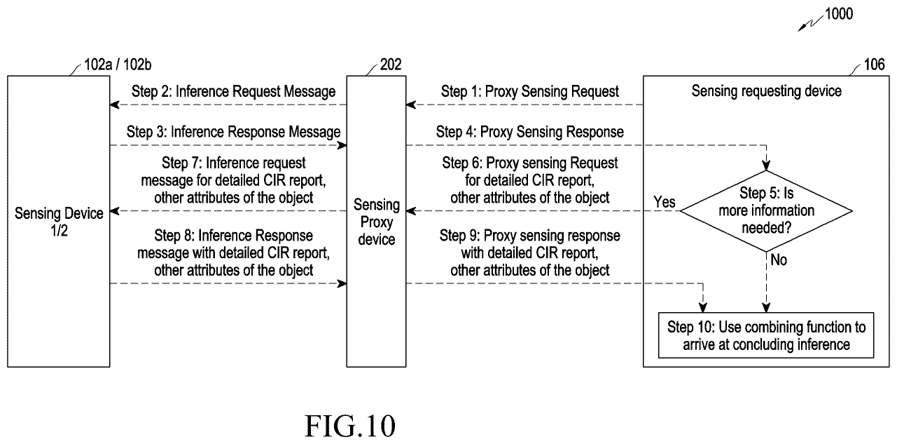

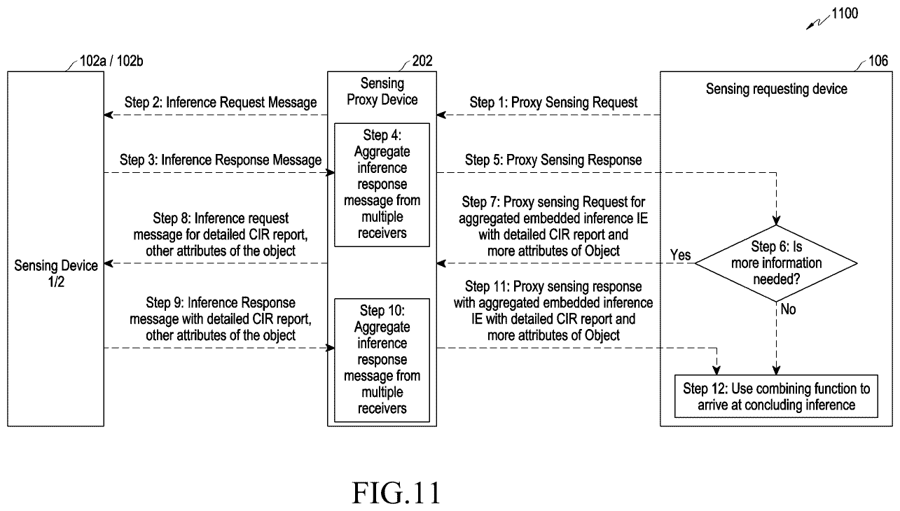

FIGS. 8 to 11 illustrate various process flows for inference in the UWB system 100, according to one or more embodiments of the present disclosure.

Specifically, FIG. 8 illustrates a process flow 800 between the sensing requesting device 106 (interchangeably referred to as “the requesting device 102”) and the sensing device 102a, 102b (interchangeably referred to as “the sensing device 102”). At step 1, the requesting device 106 may transmit an inference request message to the sensing device 102. The inference request message may correspond to the request for inference information which includes a request for the one or more attributes corresponding to the OOI 104. At step 2, the sensing device 102 transmits an inference response message to the requesting device 106. The inference response message may include the determined attributes corresponding to the OOI 104, the generated CIR report corresponding to the OOI 104, and/or the generated inference information corresponding to the OOI 104, by the sensing device 102. At step 3, the requesting device 106 may determine whether there is a need for additional information. At step 4, the requesting device 106 may transmit a request for a detailed CIR report and/or additional attributes of the OOI 104, in response to determining that there is a need for the additional information. At step 5, the sensing device 102 may transmit a response with the detailed CIR report and/or the additional attributes as requested by the requesting device 106. In the case, at step 3, the requesting device 106 determines that there is no need for additional information, the requesting device 106 may skip steps 4 and 5. At step 6, the requesting device 106 may use a combination function to combine the received inference information, attributes, and/or the CIR report from each of the sensing devices 102a, and 102b. Specifically, at step 6, the requesting device 106 may generate a concluding inference corresponding to the OOI 104.

FIG. 9 illustrates a process flow 900 among the requesting device 102, the sensing proxy device 202 (interchangeably referred as “the proxy device 202”), and the sensing device 102. At step 1, the requesting device 106 may transmit a proxy sensing request to the proxy device 202. At step 2, the proxy device 202 may transmit the inference request message to the sensing device 102 in response to the proxy sensing request from the requesting device 106. At step 3, the sensing device 102 may transmit the inference response message to the proxy device 202 in response to the inference request message from the proxy device 202. At step 4, the proxy device 106 may determine whether there is a need for additional information to generate a concluding inference for the OOI 104. At step 5, the proxy device 202 may transmit a request for a detailed CIR report and/or additional attributes of the OOI 104, in response to determining that there is a need for the additional information. At step 6, the sensing device 102 may transmit a response with the detailed CIR report and/or the additional attributes as requested by the proxy device 202. In the case, at step 4, the requesting device 106 determines that there is no need for additional information, the requesting device 106 may skip steps 5 and 6. At step 7, the proxy device 202 may use a combination function to combine the received inference information, attributes, and/or the CIR report from each of the sensing devices 102a, and 102b. Specifically, at step 7, the proxy device 202 may generate a concluding inference corresponding to the OOI 104. At step 8, the proxy device 202 may transmit the proxy sensing response to the requesting device 106, where the proxy sensing response includes the concluding inference for the OOI 104.

FIG. 10 illustrates a process flow 1000 among the requesting device 102, the proxy device 202, and the sensing device 102. At step 1, the requesting device 106 may transmit a proxy sensing request to the proxy device 202. At step 2, the proxy device 202 may transmit the inference request message to the sensing device 102 in response to the proxy sensing request from the requesting device 106. At step 3, the sensing device 102 may transmit the inference response message to the proxy device 202 in response to the inference request message from the proxy device 202. At step 4, the proxy device 202 may transmit the proxy sensing response to the requesting device 106. The proxy sensing response may include the inference response messages from the sensing devices 102. At step 5, the requesting device 106 may determine whether there is a need for additional information. At step 6, the requesting device 106 may transmit another proxy sensing request for a detailed CIR report and/or additional attributes of the OOI 104, in response to determining that there is a need for the additional information. At step 7, the proxy device 202 may transmit another inference request message for the detailed CIR report, and/or the additional attributes of the OOI 104. At step 8, the sensing device 102 may transmit another inference response message with the detailed CIR report and/or the additional attributes. At step 9, the proxy device 202 may transmit the proxy sensing response to the requesting device 106, where the proxy sensing response includes the inference response messages as received from the sensing device 102. In case, at step 5, the requesting device 106 determines that there is no need for additional information, the requesting device 106 may skip steps 6-9. At step 10, the requesting device 106 may use a combination function to combine the received inference information, attributes, and/or the CIR report from each of the sensing devices 102a, and 102b. Specifically, at step 10, the requesting device 106 may generate a concluding inference corresponding to the OOI 104.

FIG. 11 illustrates a process flow 1100 among the requesting device 102, the proxy device 202, and the sensing device 102. At step 1, the requesting device 106 may transmit a proxy sensing request to the proxy device 202. At step 2, the proxy device 202 may transmit the inference request message to the sensing device 102 in response to the proxy sensing request from the requesting device 106. At step 3, the sensing device 102 may transmit the inference response message to the proxy device 202 in response to the inference request message from the proxy device 202. At step 4, the proxy device 202 may aggregate the inference response message from the plurality of sensing devices 102 to generate a proxy sensing response. Further at step 5, the proxy device 202 may transmit the proxy sensing response to the requesting device 106. At step 6, the requesting device 106 may determine whether there is a need for additional information. At step 7, the requesting device 106 may transmit another proxy sensing request for aggregated embedded inference response with a detailed CIR report and/or additional attributes of the OOI 104, in response to determining that there is a need for the additional information. At step 8, the proxy device 202 may transmit another inference request message for the detailed CIR report, and/or the additional attributes of the OOI 104. At step 9, the sensing device 102 may transmit another inference response message with the detailed CIR report and/or the additional attributes. At step 10, the proxy device 202 may aggregate the inference response message from each of the plurality of the sensing devices 102 to generate another proxy sensing response with aggregated embedded inference response information element, the detailed CIR report, and the additional attributes of the OOI 104. At step 11, the proxy device 202 may transmit the generated proxy sensing response to the requesting device 106. In case, at step 6, the requesting device 106 determines that there is no need for additional information, the requesting device 106 may skip steps 7 and 11. At step 12, the requesting device 106 may use a combination function to combine the received inference information, attributes, and/or the CIR report from each of the sensing device 102a, and 102b. Specifically, at step 12, the requesting device 106 may generate a concluding inference corresponding to the OOI 104.

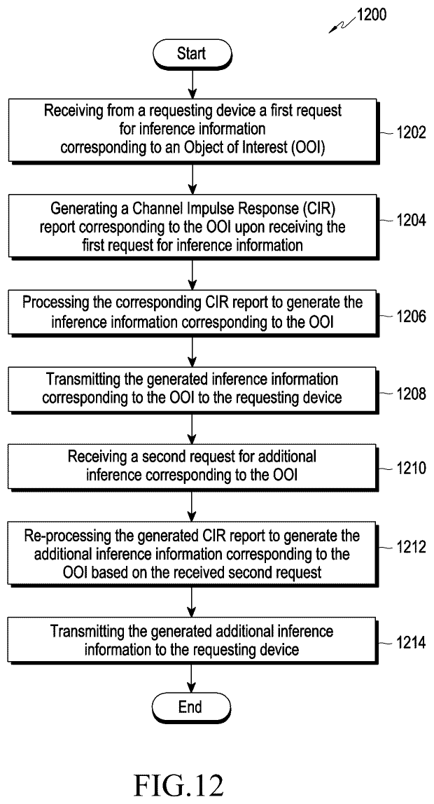

FIG. 12 illustrates a flow chart of a method 1200 for inference in the UWB at the sensing device 102, according to an embodiment of the present disclosure. FIG. 12 may be explained in reference to FIGS. 1-4.

At step 1202, the method 1200 may include receiving a first request from the requesting device 106 for inference information corresponding to the OOI 104. At step 1204, the method 1200 may include generating a Channel Impulse Response (CIR) report corresponding to the OOI 104 upon receiving the first request for inference information. Next at step 1206, the method 1200 may include processing the corresponding CIR report to generate the inference information corresponding to the OOI 104. Further, at step 1208, the method 1200 may include transmitting the generated inference information corresponding to the OOI to the requesting device 106.

At step 1210, the method 1200 may include receiving a second request for additional inference corresponding to the OOI 104. Next at step 1212, the method 1200 may include re-processing the generated CIR report to generate the additional inference information corresponding to the OOI based on the received second request. Lastly, at step 1214, the method 1200 may include transmitting the generated additional inference information to the requesting device 106.

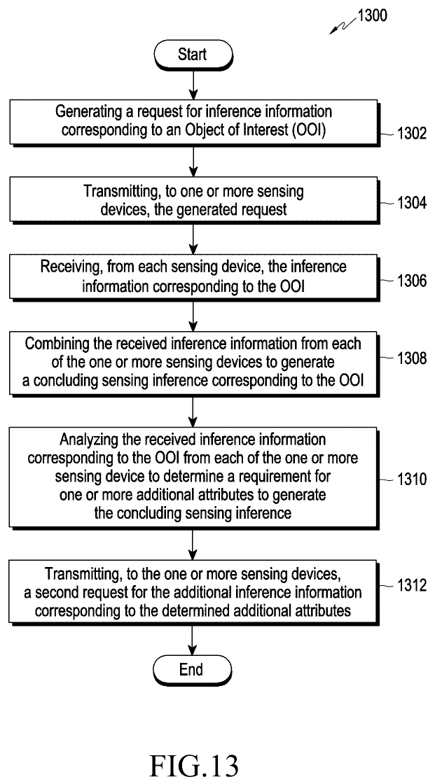

While the above discussed steps in FIG. 13 are shown and described in a particular sequence, the steps may occur in variations to the sequence in accordance with various embodiments.

FIG. 13 illustrates a flow chart of a method 1300 for inference in the UWB at the requesting device 106, according to an embodiment of the present disclosure. FIG. 13 may be explained in reference to FIGS. 1-4.

At step 1302, the method 1300 may include generating a request for inference information corresponding to the OOI 104. At step 1304, the method 1300 may include transmitting the generated request to the one or more sensing devices 102. Further, at step 1306, the method 1300 may include receiving the inference information corresponding to the OOI 104 from each of the sensing device 102.

At step 1308, the method 1300 may include combining the received inference information from each of the one or more sensing devices 102 to generate a concluding sensing inference corresponding to the OOI 104. In an embodiment, the method 1300 may include comparing at least one of confidence level corresponding to the received inference information with one or more predefined thresholds and combining a result of said comparison to generate the concluding sensing inference. Embodiments are exemplary in nature and the method 1300 may include comparing any of the receive attributes corresponding to the OOI 104 with a corresponding predefined threshold to generate the concluding sensing inference of the OOI 104. Next at step 1310, the method 1300 may include analyzing the received inference information corresponding to the OOI 104 from each of the one or more sensing device 102 to determine a requirement for one or more additional attributes to generate the concluding sensing inference. At step 1312, the method 1300 may include transmitting a second request for the additional inference information corresponding to the determined additional attributes.

While the above discussed steps in FIG. 13 are shown and described in a particular sequence, the steps may occur in variations to the sequence in accordance with various embodiments.

The present disclosure may enable effective and efficient inference of the OOI in the UWB system. Further, the present disclosure teaches use of the proxy device to generate a concluding inference of the OOI, thus the techniques provided by the present disclosure reduces load across the sensing requesting device, and/or the sensing devices. Further, the present disclosure discloses transmitting a process inference information from the sensing devices to the sensing requesting device and/or the proxy sensing device, which reduces over the air transmission among the sensing devices, the proxy sensing device, and/or the sensing requesting device. Further, the present disclosure enables faster determination of the inference of the OOI.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method performed by a first device among one or more first devices for sensing in an ultra-wide band (UWB) system including the one or more first devices and a second device being capable of communicating with the one or more first devices, the method comprising:
receiving, from the second device, a first request message for requesting inference information corresponding to an object of interest (OOI);
generating, based on the first request message, a channel impulse response (CIR) report corresponding to the OOI, the CIR report including one or more attributes corresponding to the OOI; processing the CIR report to obtain the inference information corresponding to the OOI; and
transmitting, to the second device, a first response message including the inference information corresponding to the OOI.

2. The method of claim 1, wherein receiving the first request message for inference information further comprises:
receiving a request for the one or more attributes corresponding to the OOI, the one or more attributes comprising at least one of a detection of the OOI, a location corresponding to the OOI, identification information corresponding to the OOI, a confidence level corresponding to the OOI, the CIR report corresponding to the OOI, and one or more body parameters corresponding to the OOI.

3. The method of claim 1, wherein the inference information comprises at least one of information about an inference of the OOI, information about a partial inference of the OOI, a probability indicating a match of the one or more attributes corresponding to the OOI with pre-stored object information, information about a detection of OOI, information about a location corresponding to the OOI, identification information corresponding to the OOI, a confidence level corresponding to the OOI, the CIR report corresponding to the OOI, and one or more body parameters corresponding to the OOI.

4. The method of claim 1, further comprising:
receiving, from the second device, a second request message for requesting additional inference information corresponding to the OOI, the second request message being a request message for one or more additional attributes required for generation of concluding sensing inference;
re-processing the generated CIR report to generate the additional inference information corresponding to the OOI based on the received second request message; and
transmitting, to the second device, a second response message including the additional inference information.

5. The method of claim 1, wherein the first device is a sensing device which transmits and receive signals in a UWB frequency spectrum to sense the OOI, and wherein the second device is a sensing requesting device which requests an inference corresponding to the OOI to one or more sensing devices and combines one or more inference information received from the one or more sensing devices to generate concluding sensing inference information.

6. A method performed by a second device in an ultra-wide band (UWB) system including one or more first devices for sensing and the second device being capable of communicating with the one or more first devices, the method comprising:
transmitting, to one or more first devices, a first request message for requesting inference information corresponding to an object of interest (OOI);
receiving, from each of the one or more first devices, a first response message including the inference information processed based on a channel impulse response (CIR) report, the CIR report including one or more attributes corresponding to the OOI; and
combining one or more inference information received from the one or more first devices to generate concluding sensing inference information corresponding to the OOI.

7. The method of claim 6, wherein the first request message includes one or more attributes corresponding to the OOI, the one or more attributes comprising at least one of a detection of the OOI, a location corresponding to the OOI, identification information corresponding to the OOI, a confidence level corresponding to the OOI, the CIR report corresponding to the OOI, and one or more body parameters corresponding to the OOI.

8. The method of claim 6, wherein the inference information comprises at least one of information about inference of the OOI, information about a partial inference of the OOI, a probability indicating a match of the one or more attributes corresponding to the OOI with pre-stored object information, information about a detection of the OOI, information about a location corresponding to the OOI, identification information corresponding to the OOI, a confidence level corresponding to the OOI, the CIR report corresponding to the OOI, and one or more body parameters corresponding to the OOI.

9. The method of claim 6, further comprising:
analyzing the inference information received from each of the one or more first devices to determine a requirement for one or more additional attributes to generate the concluding sensing inference information; and
transmitting, to each of the one or more first devices, a second request message for the additional inference information corresponding to the determined additional attributes.

10. The method of claim 6, wherein combining one or more inference information comprises:
comparing at least one of one or more confidence levels corresponding to the received one or more inference information with one or more predefined thresholds; and
combining the received one or more inference information based on a result of the comparison to generate the concluding sensing inference information.

11. The method claim 6, further comprising:
performing one or more actions corresponding to the OOI based on the concluding sensing inference information.

12. A first device among one or more first devices for sensing in an ultra-wide band (UWB) system including the one or more first devices and a second device being capable of communicating with the one or more first devices, the first device comprising:
a transceiver; and
a processor configured to:
receive, through the transceiver from the second device, a first request message for requesting inference information corresponding to an object of interest (OOI),
generate, based on the first request message, a channel impulse response (CIR) report corresponding to the OOI, the CIR report including one or more attributes corresponding to the OOI; processing the CIR report to obtain the inference information corresponding to the OOI, and
transmit, to the second device through the transceiver, a first response message including the inference information corresponding to the OOI.

13. (canceled)

14. A second device in an ultra-wide band (UWB) system including one or more first devices for sensing and the second device being capable of communicating with the one or more first devices, the second device comprising:
a transceiver; and
a processor configured to:
transmit, to the one or more first devices through the transceiver, a first request message for requesting inference information corresponding to an object of interest (OOI),
receive, through the transceiver from each of the one or more first devices, a first response message including the inference information processed based on a channel impulse response (CIR) report, the CIR report including one or more attributes corresponding to the OOI, and
combine one or more inference information received from the one or more first devices to generate concluding sensing inference information corresponding to the OOI.

15. (canceled)
